(19) United States
(12) Patent Application Publication
(10) Pub. No.: US 2007/0050060 A1
(43) Pub. Date: Mar. 1, 2007

(54) Digital audio signal player

(76) Inventors: Shen-Chi Liu, Tainan City (TW); Chin-Chen Ho, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/209,635

(22) Filed: Aug. 24, 2005

(51) Int. Cl. G06F 17/00

(52) U.S. Cl. 700/94

(57) ABSTRACT

A player includes an actuating mechanism, and a touch-control plate; the actuating mechanism is joined to a turntable at an output shaft; the output shaft holds a central shaft therein, which has a conductive inner part, and an insulating outer part around the inner part, and which is connected to inside of the player; the central shaft is connected to a center of a round disk on the turntable; the round disk can be manually rotated to produce scratch sound effects; the touch-control plate is conductive, and joined to the central shaft such that a touch signal will be transferred to the player inside when the plate is touched; when the output shaft makes the turntable rotate, and the touch-control plate is touched to produce a touch signal, the player will, according to the touch signal, send out a particular one of various scratch sound effects stored in the player.

### BACKGROUND OF THE INVENTION

1. Field of the Invention

The present invention relates to a digital audio signal player, more particularly one, which is convenient to use, and has more functions; allowing the user to produce scratch sound effects through manually rotating a round disk as well as through touching a touch-control plate.

2. Brief Description of the Prior Art

In order to help increase hot and exciting atmosphere in a concert or a party such as is held in a PUB or a dancing hall, the DJ usually makes the music played with scratch sound effects by means of manually moving the analogue vinyl record positioned on the turntable at changing speeds and in alternate directions. As soon as the DJ stops moving the record with his hands, the record player will start playing the record in the normal way again. However, a single analogue vinyl record has very limited capacity to store music in, and a DJ has to prepare a lot of vinyl records in every event, and the records are likely to cause the DJ inconvenience due to the large size and heavy weight. Moreover, conventional vinyl records are prone to be damaged when they are manually moved relative to the turntable. CD/MP3 records have larger capacity, and are smaller in size and more convenient to use than conventional vinyl records.

Therefore, various types of audio signal players are developed for DJ to play CD/MP3 records and produce scratch sound effects.

Referring to FIG. 4, a currently available digital audio signal player 3 includes an actuating device 31, a turntable 32, a grating 33, and an optical sensor 34. The actuating device 31 has an output shaft 311. The turntable 32 is secured around an upper end of the output shaft 311 while the grating 33 is secured around a lower end of the output shaft 311; thus, the turntable 32 and the grating 33 will rotate at the same speed and in the same direction when the output shaft 311 rotates. The optical sensor 34 is used for detecting movement of the grating 33. When the user is manually rotating a round disk 321 positioned on the turntable 32 to produce various scratch sound effects, he would possibly change the speed of rotation of the turntable 32. Because of the optical sensor 34 and the grating 33, the speed and direction of rotation of the turntable 32 will be found out when the user is manually rotating the round disk 321.

Referring to FIG. 5, another currently available digital audio signal player 4 includes an actuating device 41, a turntable 42, a magnet seat 43, an induced magnet 431, and a magnetic sensing plate 432. The actuating device 41 has an output shaft 411. The turntable 42 is secured around an upper end of the output shaft 411, and the magnet seat 43 and the turntable 42 will rotate at the same speed and in the same direction when the output shaft 411 rotates. The induced magnet 431 is secured on a bottom side of the magnet seat 43. The magnetic sensing plate 432 is used for detecting movement of the induced magnet 431. When the user is manually rotating a round disk 421 positioned on the turntable 42 to produce various scratch sound effects, he would possibly change the speed of rotation of the turntable 42. Because of the magnetic sensing plate 432 and the induced magnet 431, the speed of rotation of the turntable 42 will be found out.

Referring to FIG. 6, yet another currently available digital audio signal player 5 includes a hollow housing part 51, a playing device 52, a turntable mechanism 53, an actuating mechanism 54, and a signal reading mechanism 55. The playing device 52 is used for playing a CD. The turntable mechanism 55 includes first and second turntables 531, 532 on an upper side of the hollow housing part 51, and a coupling plate 533 sandwiched between the first and the second turntables 531, 532. The actuating mechanism 54 includes a rotary shaft 541, and an electromagnetic rotating seat 542; the rotary shaft 541 projects from the upper side of the hollow housing part 51, and is connected to the turntable mechanism 53 such that the turntable mechanism 53 and the rotary shaft 541 can rotate at the same speed and in the same direction; the electromagnetic rotating seat 542 is used for making the turntable mechanism 53 rotate. The signal reading mechanism 55 includes first and second light blocking plates 551, 553, first and second photoelectric interrupters 552, and 554, the first light blocking plate 551 will rotate at the same speed and in the same direction as the first turntable 531 while the second light blocking plate 553 will rotate at the same speed and in the same direction as the rotary shaft 541; the first photoelectric interrupter 552 will read signals of the first light blocking plate 551 while the second photoelectric interrupter 554 will read signals of the second light blocking plate 553. Therefore, the playing device 52 will produce normal audio effects when the turntables 531, 532 rotate in the same direction and at the same speed. And, the playing device 52 will produce scratch sound effects when the first and the second turntables 531, 532 rotate in different directions or at different speeds.

From the above description, it can be seen that when the above-mentioned digital audio signal players are used, the users are allowed to manually rotate the records on the turntables so as to produce certain scratch sound effects. However, it isn't very convenient to use such method to produce scratch sound effects. Furthermore, such method of producing scratch sound effects has its limitation; the users can only produce some certain kinds of audio special effects, and he isn't allowed to use other methods to add other scratch sound effects to the current ones while manually rotating the records on the turntables.

### SUMMARY OF THE INVENTION

It is a main object of the invention to provide an improvement on a digital audio signal player to overcome the above-mentioned problem. The digital audio signal player includes an actuating mechanism, and a touch-control plate; the actuating mechanism is joined to a center of a turntable mechanism at an output shaft; the output shaft holds a central shaft therein, which has an electricity-conductive inner part, and an insulating outer part wrapped around the inner part, and which is electrically connected to inside of the player by means of wires; the central shaft is further connected to a center of a round disk supported on the turntable mechanism at an upper end such that the central shaft and the round disk will rotate in the same direction and at the same speed; the round disk can be manually rotated to produce scratch sound effects. The touch-control plate is made of electricity-conductive materials, and positioned over and joined to the upper end of the central shaft such that when the touch-control plate is touched to produce touch signals, the touch signals will be transferred to the inside of the player. Therefore, while the output shaft is making the turntable mechanism rotate, the user is also allowed to touch the touch-control plate so as to produce a touch signal, and in turn the player will, according to the touch signal, send out a particular one of various scratch sound effects stored in the player.

### BRIEF DESCRIPTION OF THE DRAWINGS

The present invention will be better understood by referring to the accompanying drawings, wherein:

FIG. 1 is a partial exploded perspective view of the digital audio signal player in the present invention,

FIG. 2 is a lateral sectional view of the present invention,

FIG. 3 is a perspective view of the present invention in use,

FIG. 4 is a lateral sectional view of the first currently available digital audio signal player,

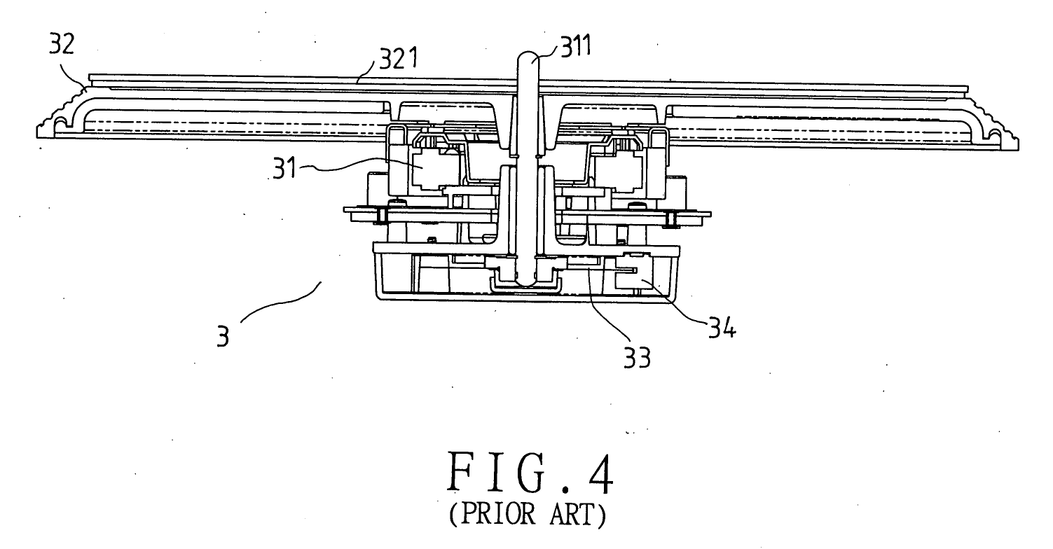

FIG. 5 is a lateral sectional view of the second currently available digital audio signal player, and

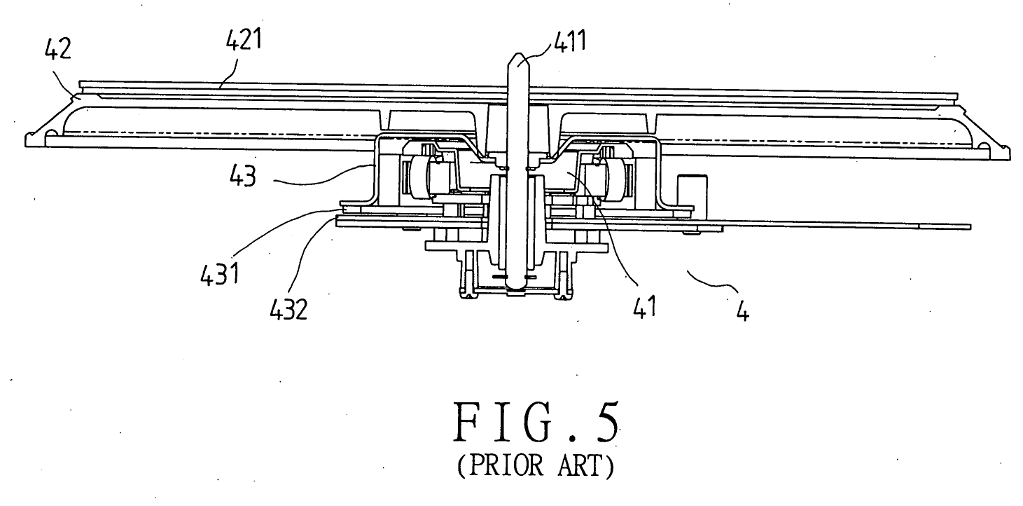

FIG. 6 is a lateral sectional view of the third currently available digital audio signal player.

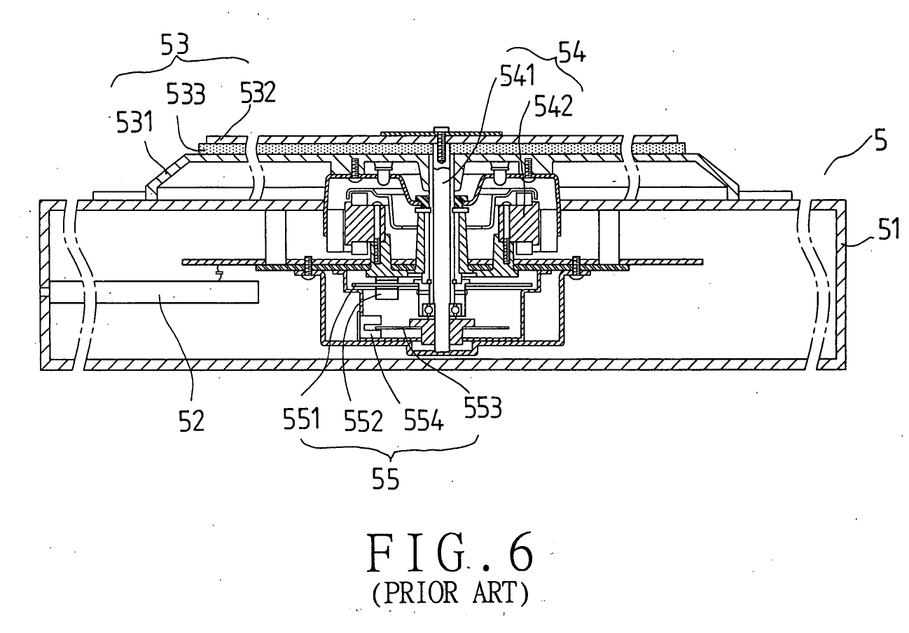

### DETAILED DESCRIPTION OF THE PREFERRED EMBODIMENTS

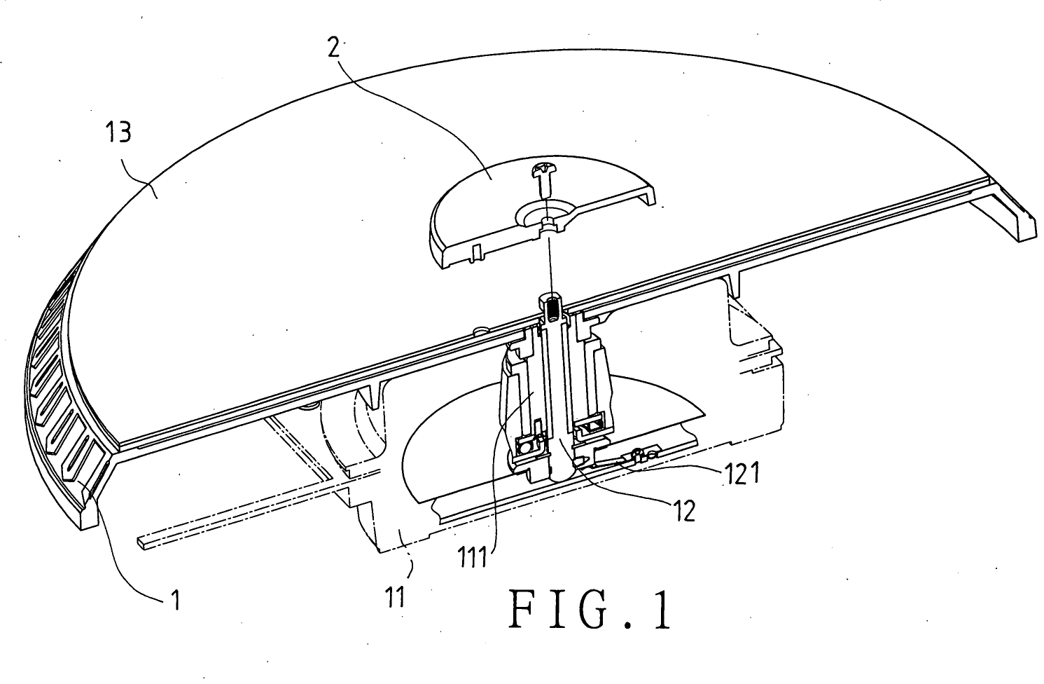

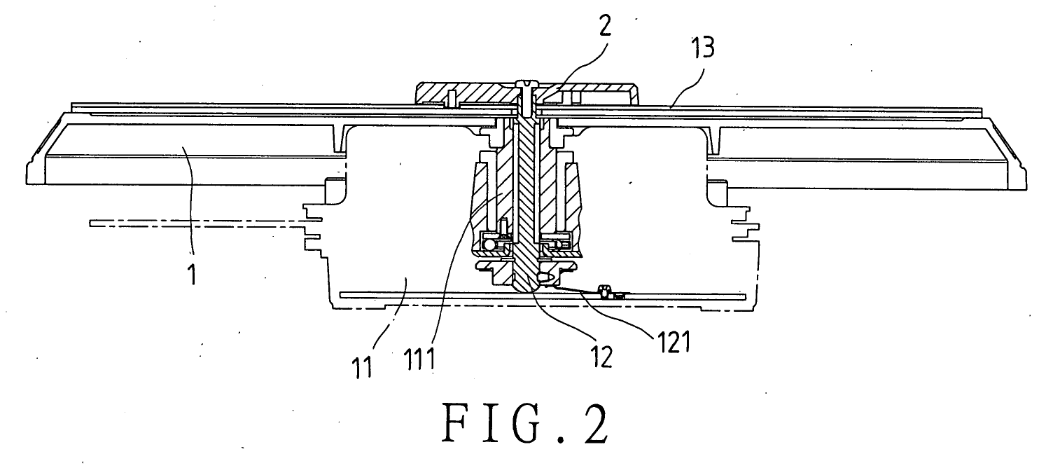

Referring to FIGS. 1 and 2, a preferred embodiment of a digital audio signal player includes a turntable mechanism 1, an actuating mechanism 11, and a touch-control plate 2.

The actuating mechanism 11 has an output shaft 111, which is securely joined to a center of the turntable mechanism 1. The output shaft 111 holds a central shaft 12 therein, which is electrically connected to inside of the digital audio signal player by means of wires 121, and which has an inner part made of electricity-conductive materials, and an insulating outer part wrapped around the electricity-conductive inner part. The central shaft 12 is connected to a center of a round disk 13 positioned on the turntable mechanism 1 at an upper end thereof such that the central shaft 12 and the round disk 13 will rotate in the same direction and at the same speed. The touch-control plate 2 is made of electricity-conductive materials, and positioned over and joined to the upper end of the central shaft 12 such that when the touch-control plate 2 is touched to produce touch signals, the touch signals will be transferred to the inside of the digital audio signal player through the central shaft 12 as well as the wires 121.

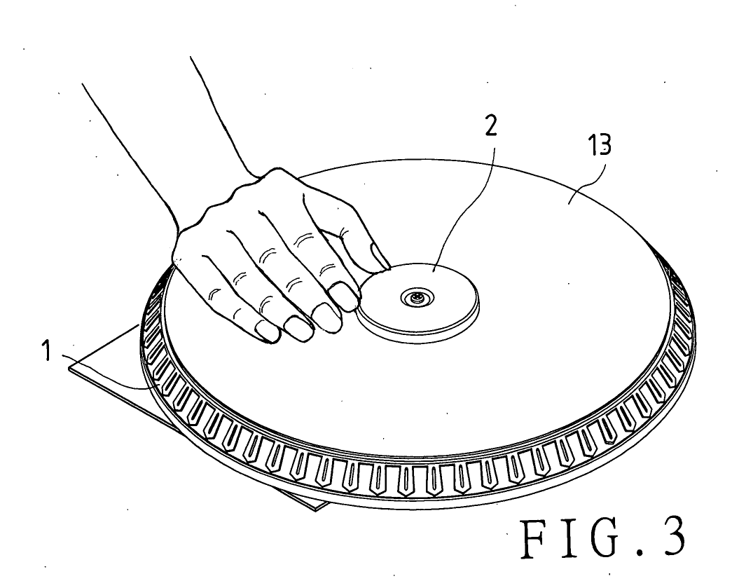

Therefore, referring to FIG. 3, while the output shaft 111 of the actuating mechanism 11 is making the turntable mechanism 1 rotate together with it, the user is allowed to touch the touch-control plate 2 so as to produce a touch signal. The touch signal will be immediately transferred to the inside of the digital audio signal player through the central shaft 12 as well as the wires 121, and in turn the digital audio signal player will, according to the touch signal, send out a particular one of various scratch sound effects, which are previously stored in a memory of the digital audio signal player. Or alternatively, the user can touch the touch-control plate 2 so as to make the digital audio signal player send out a particular one of the scratch sound effects previously stored in the memory of the digital audio signal player while he is manually rotating the round disk 13 to produce other scratch sound effects.

From the above description, it can be easily seen that the digital audio signal player of the present invention is more convenient to use, and has more functions when compared with the conventional ones; besides allowing the user to produce scratch sound effects through manually rotating the round disk, the present digital audio signal player allows the user to produce additional scratch sound effects through touching the touch-control plate.

What is claimed is:

1. A digital audio signal player, comprising
a turntable mechanism;
an actuating mechanism joined to a center of the turntable mechanism at an output shaft thereof; the output shaft holding a central shaft therein, which has an electricity-conductive inner part, and an insulating outer part wrapped around the electricity-conductive inner part, and which is electrically connected to inside of the digital audio signal player by means of wires; the central shaft being connected to a center of a round disk positioned on the turntable mechanism at an upper end such that the central shaft and the round disk will rotate in same direction and at same speed; and
a touch-control plate made of electricity-conductive materials; the touch-control plate being positioned over and joined to the upper end of the central shaft such that when the touch-control plate is touched to produce touch signals, the touch signals will be transferred to the inside of the digital audio signal player through the central shaft and the wires;
whereby while the output shaft is making the turntable mechanism rotate together with it, a person is allowed to touch the touch-control plate so as to produce a touch signal, thus making the digital audio signal send out, according to the touch signal, a particular one of various scratch sound effects, which are stored in the digital audio signal player; and
whereby while the round disk is being manually rotated to produce scratch sound effects, a person is allowed to touch the touch-control plate so as to make the digital audio signal player send out a particular one of the various scratch sound effects stored in the digital audio signal player.
